(19) United States
(12) Patent Application Publication
(10) Pub. No.: US 2007/0140610 A1
(43) Pub. Date: Jun. 21, 2007

(54) Bearing device for mounting of a high-speed rotor

(75) Inventor: Wilheim Birkenmaier, Weinstadt (DE)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Texparts Gmbh, Fellbach (DE)

(21) Appl. No.: 10/587,639

(22) PCT Filed: Nov. 23, 2004
(86) PCT No.: PCT/EP04/13276

§ 371 Date: Jul. 28, 2006

(30) Foreign Application Priority Data
Feb. 18, 2004 (DE) 102004007758.4

(51) Int. Cl. F16C 27/00

(52) U.S. Cl. 384/536

(57) ABSTRACT

The invention relates to a bearing device (1), for mounting a high-speed rotor, with a rotor bearing and a damping device. The rotor bearing comprises a bearing ring (6) and the damping device a damping inner sleeve (7). The bearing ring (6) is enclosed by the damping inner sleeve (7) and connected to the damping inner sleeve (7) for fixing, by means of a screw (11). The bearing ring (6) comprises an internal thread (10) in which the thread of the screw (11) engages. The damping inner sleeve (7) comprises an opening (14) which permits the free passage of the screw (11). A pressure distribution element (15) is provided on the damping inner sleeve (7) for housing the screw (11). The bearing device (1) serves for the mounting of spinning rotors (2) on open-end spinning devices. Said embodiment of the bearing device (1) facilitates assembly, adjustment and maintenance. The costs of the bearing device (1) are reduced.

The invention relates to a bearing device for mounting a high-speed rotor according to the preamble of claim 1.

High-speed rotor bearings of this type are used on open end spinning machines and are fastened in the inner sleeve of a damping device in order to be able to reduce the high dynamic forces occurring. The inner sleeve is held in the rotor housing by rubber-elastic elements. A connection which is as rigid as possible is produced between the rotor bearing and inner sleeve of the damping device in order to prevent additional natural resonances caused by inherent elasticity from occurring. The rotor bearing has to be axially adjustable with the rotor in the rotor housing in order to be able to adjust the rotor into the correct position with respect to the elements of the fibre feed and the fibre take-off. This axial positioning can be carried out by displacing the rotor bearing together with the annular damping elements of the damping device in the rotor housing or by displacing the rotor bearing alone in already prefixed damping elements.

The annular damping elements become fixed after a relatively long spinning operation owing to dirt, dust and vibration corrosion in the rotor housing. They can then no longer be finely axially displaced to adjust the rotor bearing. The displacement of the rotor bearing together with the damping elements in the rotor housing is therefore avoided if possible. If the damping elements and rotor bearing are installed and maintained as components which are independent of one another, the rotor bearing is thus preferably adjusted by displacement of the rotor bearing in the damping elements.

A bearing arrangement for spinning rotors on open end spinning machines is known from DE 38 37 733 A1, in which the inner sleeve of the damping elements comprises a peripheral rim arranged in the centre with a continuous threaded hole. A cylinder head screw with a slotted head and opposing point is screwed as far as the screw head will go into the threaded hole. A groove with an inserted ring extends around the outer bearing ring. The ring is generally made of plastics material or a similar deformable material. The point of the cylinder head screw penetrates into the plastics material ring and thus firmly clamps the rotor bearing. Every time the rotor bearing is taken out for maintenance purposes, a new axial adjustment must be made and care has to be taken that the screw point penetrates the plastics material ring at a new position. The transmission of the clamping force via the small area of the screw point is also disadvantageous. If the plastics material creeps, the clamping force of the screw point and therefore the fastening security of the rotor bearing declines. If the rotor bearing is frequently disassembled, it may become necessary to replace the plastics material ring by a new one as the used plastics material ring has a large number of pressing in traces from the point of the cylinder screw and thus reliable clamping of the rotor bearing is no longer ensured.

DE 199 01 565 A1 discloses a bearing of a spinning rotor of an open end spinning machine with a regreasing system. The regreasing system is elaborate with regard to the components and assembly required. The outer bearing ring is fastened to the inner sleeve of the damping mechanism by means of a cylinder head screw with a slotted head. The screw is not held by a thread introduced into the inner sleeve in this embodiment, but by an attachment piece with an internal thread rigidly connected to the inner sleeve. The attachment piece generally consists of a welded-on nut. When the screw is tightened, the force acts in the direction of releasing the nut. The nut therefore has to be fastened as well as can be achieved by welding on or the internal thread has to be part of the damping inner sleeve. It is a disadvantage in a welded-on nut that conventional commercial standard welding nuts and normal resistance welding cannot be used because of the curved surface of the inner sleeve. Heating can also lead to deformations of the damping inner sleeve. The screw has no head which penetrates into the plastics material ring extending around the inner sleeve. The screw merely presses flatly onto the plastics material ring which is also present here. The outer bearing ring is fixed only by clamping. There is no assistance of the clamping by plastic deformation by means of a penetrating point in this embodiment. The wear to the plastics material ring and therefore the necessity of replacing the plastics material ring after some time disadvantageously remains, however.

The object of the invention is to improve the known bearings for rotors.

This object is achieved with a bearing device with the features of claim 1.

Advantageous configurations of the invention are the subject of the sub-claims.

The bearing device according to the invention ensures reliable and long term fixing between the damping inner sleeve and bearing ring. A plastics material clamping ring and the introduction of peripheral grooves into the bearing ring are no longer necessary. Deformations owing to welding on of a nut can no longer occur. The connection between the bearing ring and damping inner sleeve is produced by tension owing to the arrangement of the screw according to the invention. In contrast to an embodiment with a welded-on nut according to the prior art, the connection between the pressure distribution element and damping inner sleeve is reinforced thereby and not as claimed in the prior art. This produces the possibility of a releasable fastening, which leads to a reduction in the manufacturing outlay compared to the prior art. The alternative embodiment of a peripheral rim around the damping inner sleeve can be dispensed with. For this reason, the processing outlay is above all reduced in the production of the damping inner sleeve. The outlay for fitting, maintenance and adjustment is reduced and contributes to the reduction in costs.

If the screw is held in the position released from the internal thread of the bearing ring by the pressure distribution element, the screw becomes a captive part of the damping inner sleeve. The bearing device is therefore more assembly-friendly.

If an opening in the damping inner sleeve is configured, according to claim 4, as a slot in the axial direction and the rotor bearing is axially displaceable relative to the damping inner sleeve when the screw is released, an adjustment of the rotor bearing or the spinning rotor is rapidly and easily possible. This possibility is also provided by the fact that the pressure distribution element is attached releasably and is axially displaceable on the damping inner sleeve.

If the pressure distribution element has ring segment-shaped holding arms, with which it can be latched onto the damping inner sleeve, simple and rapid provision of the pressure distribution element on the damping inner sleeve is possible. The pressure distribution element, as described, remains axially displaceable to a limited degree for simple adjustment.

A configuration of the pressure distribution element according to claim 6, and a configuration of the screw according to claim 7, ensure good contact of the screw head and good distribution of the contact force on the damping inner sleeve. The moulded-on disc makes secure holding of the screw in notches of the latching hooks possible.

Owing to an embodiment of the screw according to claim 8, an elaborate regreasing device, such as is known, for example, from DE 199 01 565 A1 can be dispensed with. The regressing process can be carried out easily.

If the pressure distribution element consists of elastic material, the provision of the pressure distribution element and holding of the screw are easy.

Pressure distribution elements according to claim 10 and claim 11 allow economical production.

The connection of the bearing ring and damping inner sleeve by means of clamping by frictional engagement and plastic deformation is advantageously replaced by a positive and wear-free connection. The bearing device according to the invention advantageously allows reliable bearing fastening and simple regreasing by means of the two components, pressure distribution element and screw. All the parts can be economically produced. The bearing device is easy to assemble and facilitates maintenance and adjustment.

Further details of the invention can be inferred from the embodiments of the figures, in which:

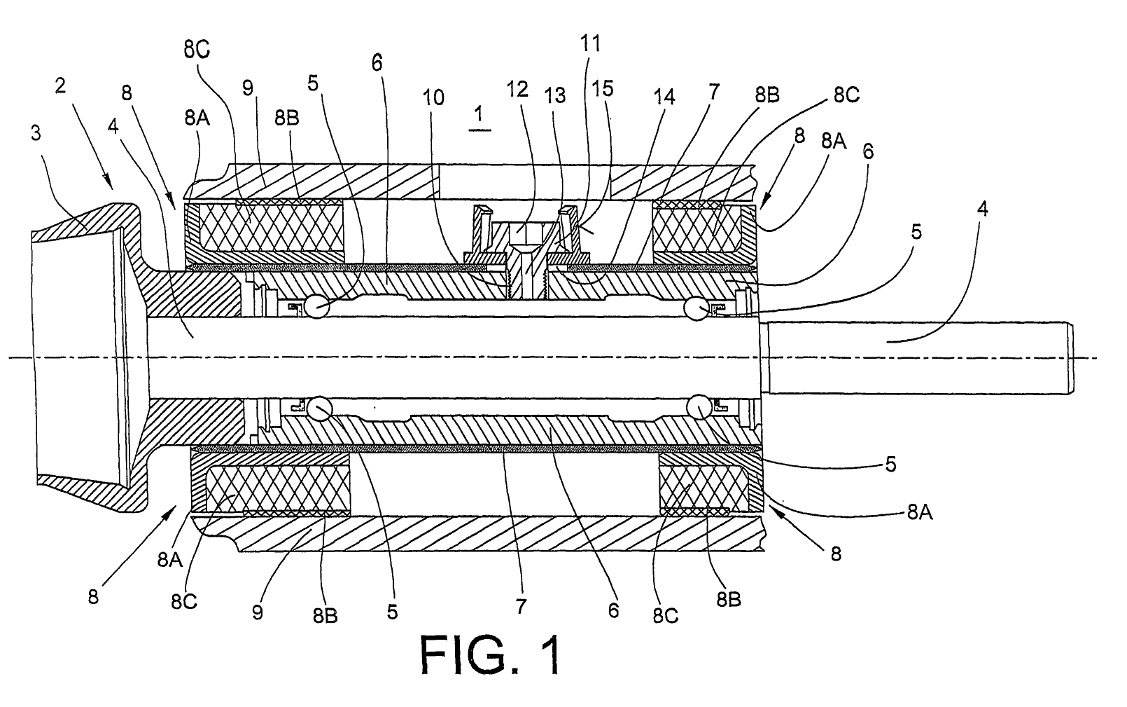

FIG. 1 shows a section through a bearing device with a spinning rotor,

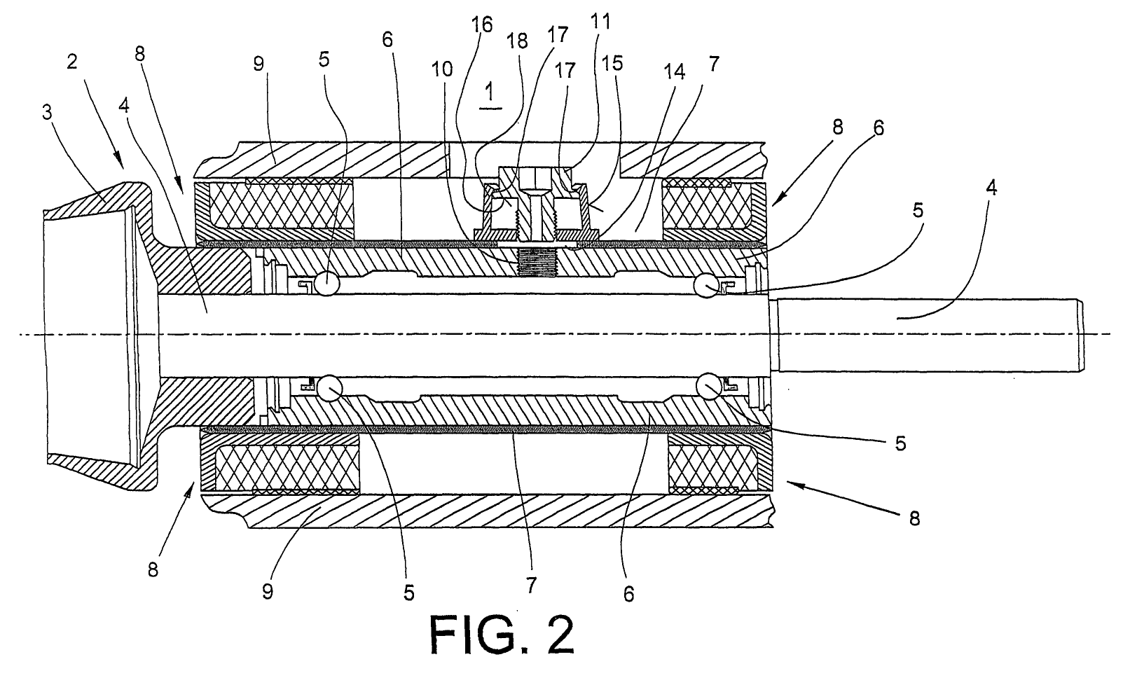

FIG. 2 shows the bearing device of FIG. 1 with the released screw in section,

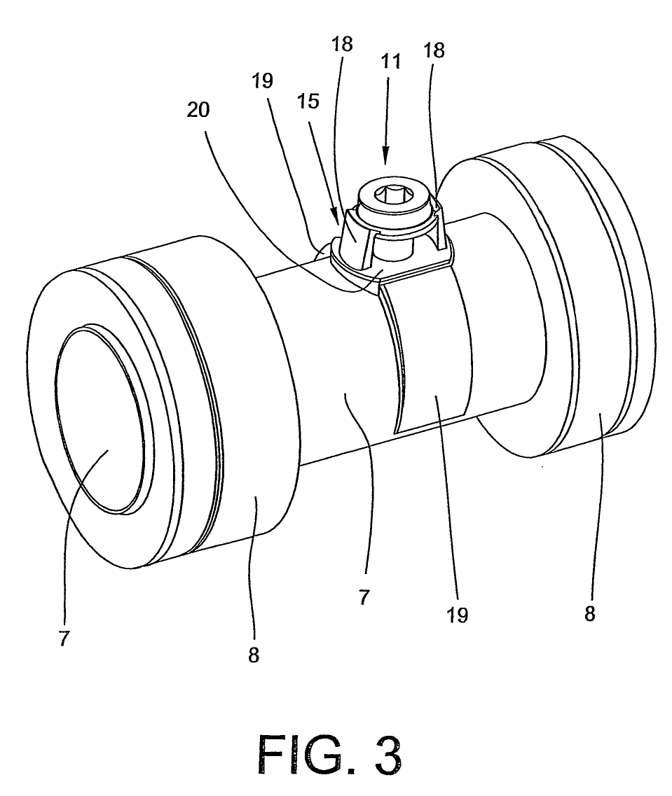

FIG. 3 shows a perspective view of the bearing device of FIG. 2,

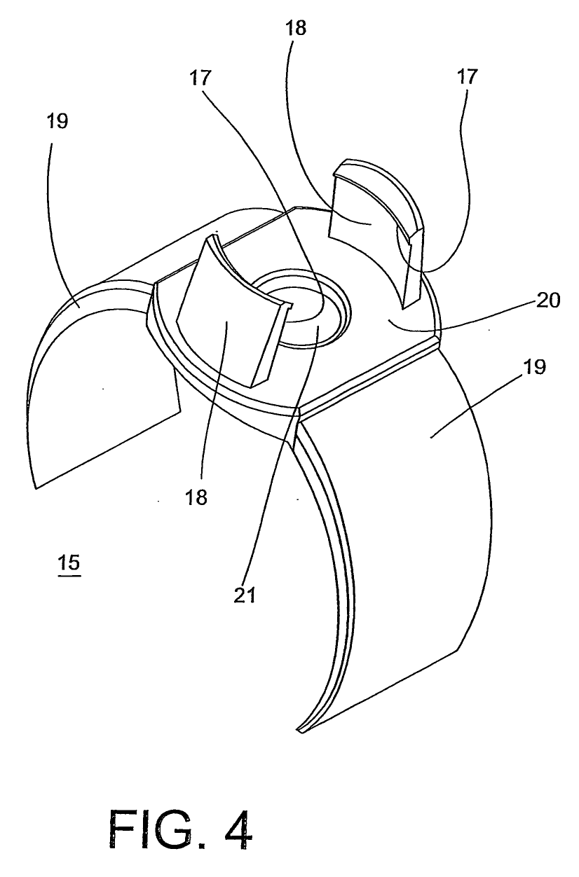

FIG. 4 shows a perspective view of a holding element.

FIG. 1 shows a bearing device 1 for mounting a spinning rotor 2. The spinning rotor 2 consists of a rotor plate 3 and a rotor shaft 4. The rotor shaft 4 is rotatably mounted in a bearing ring 6 by means of a ball bearing mechanism 5. The bearing ring 6 is surrounded by a damping inner sleeve 7, which is in turn fastened in rubber-elastic annular damping elements 8. The damping elements 8 in each case comprise an inner reinforcing ring 8A and an outer reinforcing ring 8B made of steel and a vulcanised-in rubber ring 8C and are held in a housing 9. The bearing ring 6 has a continuous internal thread 10, in which a screw 11 engages. The screw 11 is configured as a cylinder head screw with a hexagon socket 12. A regreasing hole 13 leads through the screw 11. The ball bearing mechanism 5 can be regreased easily and without great structural outlay by means of the regreasing hole 13. The screw 11 engages through an opening 14 of the damping inner sleeve 7 and, in the tightened state, loads a pressure distribution element 15 with a force in the direction of the bearing ring 6 and presses the damping inner sleeve 7 against the bearing ring 6. A rigid connection is thus produced between the bearing ring 6 and the damping inner sleeve 7 and the bearing ring 6 is fixed in its position.

In FIG. 2, the screw 11 no longer engages in the internal thread 10 and is located in a position which is released and spaced apart from the bearing ring 6. The screw 11 has a disc 16 moulded onto the cylinder head. The disc 16 engages, in the position spaced apart from the bearing ring 6, in notches 17 of two mutually opposing elastic latching hooks 18 of the pressure distribution element 15. The spacing between the latching hooks 18 reduces toward their free ends.

If the screw is unscrewed from the internal thread, the disc 16 presses the latching hooks 18 apart during unscrewing and latches finally in the notches 17 of the latching hooks 18. In this position, the screw 11 is held by the pressure distribution element 15 reliably and easily, cannot become lost and is already positioned appropriately for subsequent screwing into the internal thread 10 of the bearing ring 6. The bearing ring 6 of the rotor bearing can be axially displaced and disassembled in this position of the screw 11.

Limited axial displacement of the bearing ring 6 is already possible when the screw 11 is only unscrewed by a few rotations and therefore the pressing of the damping inner sleeve onto the bearing ring 6 is eliminated. The screw 11 can move in the opening 14, which is designed as a slot in the axial direction and entrains the pressure distribution element 15. An adjustment of the position of the bearing ring 6 or the spinning rotor 2 is thus possible, rapidly and easily, without great outlay for assembly.

The pressure distribution element 15 of FIG. 2 with the screw 11 in the position released from the internal thread 10 of the bearing ring 6, the bearing ring 6 together with the spinning rotor 2 being disassembled, is shown in FIG. 3 in a perspective view. The damping device comprises the annular damping elements 8 and the damping inner sleeve 7, the damping elements 8 being provided on the ends of the damping inner sleeve 7.

The pressure distribution element 15 is arranged on the damping inner sleeve 7 in such a way that the screw 11 cannot penetrate through the opening 14, not visible in FIG. 3. The screw 11 is held by both latching hooks 18. The holding arms 19 have sufficient elasticity to open on provision of the pressure distribution element 15 on the damping inner sleeve 7 so wide that the pressure distribution element 15 can be latched on and to then be placed on the damping inner sleeve 7. The pressure distribution element 15 is adapted to the cylindrical form of the damping inner sleeve 7 on the side facing the damping inner sleeve 7. The latching hooks 18 are arranged at the edge of a flat support 20 on which the lower side of the cylinder head of the screw 11 rests. This makes good distribution of the contact force possible when the screw 11 is tightened.

FIG. 4 shows a view of the pressure distribution element 15 which is enlarged compared to FIGS. 1 to 3. The curvature on the inner side of the holding arms 19 can be clearly seen in this view. The latching hooks 18 with the notches 17 can encompass and retain well the disc 16 formed on the cylinder head of the screw 11 owing to the mutually opposing arrangement, when the screw 11 has been unscrewed from the internal thread 10.

When unscrewing the screw 11 with the aid of a wrench introduced into the hexagonal socket of the screw head, from a specific position, the disc 16 touches the latching hooks 18 and presses them apart while turning further. When the screw 11 has been released from the internal thread 10, it is pulled up slightly by hand, until the disc 16 has reached the notches 17 and latches in there. To screw the screw 11 in again, it is pressed downwardly and the disc 16 is thus released from the notches 17. The screw 11 engages through the hole 21 of the pressure distribution element 15 in the internal thread 10 of the bearing ring 6 and can now be tightened again. The pressure distribution element 15 is designed as an injection moulding produced from plastics material.

The previously conventional connection of the bearing ring 6 and damping inner sleeve 7 by means of a screw in a known embodiment, wherein a clamping acts by means of frictional engagement and plastic deformation, is advantageously replaced by a positive, wear-free and reliable connection, the screw 11 of which does not become lost, as it is held by the pressure distribution element 15, in the unscrewed state.

1. Bearing device for mounting a high-speed rotor with a rotor bearing and a damping device, wherein the rotor bearing has a bearing ring and the damping device has a damping inner sleeve, and wherein the bearing ring is surrounded by the damping inner sleeve and can be rigidly connected to the damping inner sleeve for fixing, by means of a screw, characterized in that the bearing ring (6) has a radially peripheral internal thread (10), in which the thread of the screw (11) engages, in that the damping inner sleeve (7) has an opening (14), in that a pressure distribution element (15) is arranged on the damping inner sleeve (7) and has a hole (21) which is flush with the opening (14), and in that the opening (14) and the hole (21) are dimensioned such that they allow free passage of the screw (11).

2. Bearing device according to claim 1, characterized in that the pressure distribution element (15) is configured such that the screw (11) is held in a position released from the internal thread (10) of the bearing ring (6) by the pressure distribution element (15).

3. Bearing device according to claim 2, characterized in that the pressure distribution element (15) has two latching hooks (18) for holding the screw (11).

4. Bearing device according to claim 1, characterized in that the opening (14) is configured as a slot in the axial direction, and in that the rotor bearing is axially displaceable relative to the damping inner sleeve (7) when the screw (11) is released.

5. Bearing device according to claim 1, characterized in that the pressure distribution element (15) has ring segment-shaped holding arms (19), with which it can be latched onto the damping inner sleeve (7).

6. Bearing device according to claim 1, characterized in that the screw (11) has a disc (16) molded onto the screw head and projecting over the screw head for enlarging the contact face of the screw head.

7. Bearing device according to claim 1, characterized in that the pressure distribution element (15) has a flat support (20) for the screw head.

8. Bearing device according to claim 1, characterized in that the screw (11) has a regreasing hole (13).

9. Bearing device according to claim 1, characterized in that the pressure distribution element (15) consists of an elastic material.

10. Bearing device according to claim 9, characterized in that the pressure distribution element (15) consists of plastics material.

11. Bearing device according to either of claims 9 or 10, characterized in that the pressure distribution element (15) is produced as an injection molding.
